(19) United States
(12) Patent Application Publication
(10) Pub. No.: US 2002/0107925 A1
(43) Pub. Date: Aug. 8, 2002

(54) Method and system for e-mail management

(76) Inventors: Robert Goldschneider, Sharon, MA (US); Michael Hren, Lexington, MA (US); Weidong Wang, Lexington, MA (US)

Correspondence Address: Yong S. Choi, MINTZ, LEVIN, COHN, FERRIS,, GLOVSKY and POPEO, P.C., One Financial Center, Boston, MA, 02111, US

(21) Appl. No.: 09/778,021

(22) Filed: Feb. 5, 2001

(51) Int. Cl. G06F 15/16; G06F 7/00; G06F 17/30

(52) U.S. Cl. 709/206; 707/6; 707/10

(57) ABSTRACT

A method and system provides a user with a permanent electronic mail (e-mail) address that the user uses to distribute to persons and entities that the user desires to have contact with. A list of addresses of persons and entities that the user desires to keep contact with is set up along with associated forwarding addresses. When an e-mail is received, the source address of the e-mail is compared with the list. If there is a match, the forwarding address is retrieved and the e-mail is forwarded using the forwarding address. If there is no match, the source address and/or the e-mail is stored, which is accessible by the user.

### FIELD IF THE INVENTION

The invention relates to electronic information management and in particular, to management of e-mails destined to an individual or entity through a network.

### BACKGROUND OF THE INVENTION

The advent of telecommunication and computer technologies have brought about improved means in which information is transmitted. A prodigy of those technologies, the Internet is a worldwide network that connects various individuals and entities together to provide for an interchange of information, ideas and commercial transactions. Many commercial and non-commercial entities, and individuals have set up “Websites” so that one may visit the site through the Internet to engage in a commercial transaction or merely to obtain information. A useful tool that has evolved with network technologies is the electronic mail (e-mail) that allows its users to send information at speeds allowable by the network. Typically, the recipient is able to receive the e-mail almost instantaneously from the time the e-mail is sent. Techniques used to drive e-mail may also similarly be used by commercial entities to drive “SPAM.” SPAM usually refers to an unsolicited commercial message that is targeted to a particular user or group of users, or is simply broadcasted based on a distribution list, for example. A rationale behind SPAM is that hopefully the content of the message will stimulate a user into buying the sender's product or service. In many cases, however, SPAMs simply annoy and take up memory space in the user's e-mail box.

SPAM is one example of electronic commerce (e-commerce), in particular, business to customer commerce (B2C commerce). With the advancement of wireless technology, such as a laptop computer with wireless modem, a wireless Personal Digital Assistant (PDA) and mobile phone, all of which that enhances user mobility, the technology has evolved a form of commerce known as mobile commerce (m-commerce). For example, a user using a mobile phone with Wireless Access Protocol (WAP) capability is able to perform a commercial transaction such as buying or selling stocks via the user's online account or simply gain access to the user's e-mail account while the user is in transition. However, SPAM may also gain access to the user's e-mail account and overwhelm the account with junk messages that mingle with important messages that the user may want to retrieve. This creates a nuisance, in particular, to wireless devices where the information processing and display capabilities have been minimized to accommodate the device's portability. In another situation, a typical user possesses several e-mail accounts. For instance, the user may have an e-mail account provided by an employer, a personal e-mail account, a dedicated mobile phone e-mail account and other e-mail accounts set up for various purposes. The user may have difficulty in managing all of these accounts. In another instance, the user may frequently cancel an email account and create another. In this instance, the user may lose track of who possesses the current e-mail address thereby inadvertently loses an e-mail contact. So far, many examples have been given using e-mail as an example, however, it should be noted that the examples encompass the transmission of multimedia contents that comprise individual or combination of audio, video, text, images and the like. What is needed is a solution that solves these and other shortcomings.

### SUMMARY OF THE INVENTION

The present invention overcomes to a great degree the deficiencies of prior systems by providing an e-mail management system which forwards and blocks e-mails in accordance with users' desires to prevent receipt of SPAM. The e-mail management system further allows users to receive e-mails at a single location and have the messages forwarded to one or more locations. In this manner, a user can easily change e-mail addresses without having to notify everyone of the new address.

The e-mail management system of the present invention includes a server which receives all e-mails directed to its user's accounts. All e-mails are reviewed against various lists for filtering. The lists may include contacts, information sources, subjects or other information which the user identifies as desirable. If a received e-mail corresponds to one of the user's desired emails, such as being from an allowed contact, the e-mail is forwarded to a location indicated by the user, such as a personal e-mail address, a business e-mail address, a PDA, or cellular phone. If an e-mail does not correspond to the user's desired emails, it is placed in temporary storage and listed on a block log. The block log is periodically provided to the user for review. The user can retrieve blocked e-mail messages and can add to his or her lists from the information in the blocked log.

### BRIEF DESCRIPTION OF THE DRAWINGS

For better understanding of the invention, reference is made to the drawings which are incorporated herein by reference and in which:

FIG. 1 illustrates an example of a network environment in which an embodiment of the invention may be implemented;

FIG. 2 illustrates a general-purpose computer in which an embodiment of the invention may be practiced;

FIG. 3 illustrates a mobile phone in which an embodiment of the invention may be practiced;

FIG. 4 is a schematic diagram of an electronic mail (e-mail) management server in accordance with an embodiment of the invention;

FIG. 5 illustrates an exemplary graphic user interface (GUI) that shows a Contact List in accordance with an embodiment of the invention;

FIG. 6 illustrates an exemplary GUI that shows an Information Source List in accordance with an embodiment of the invention;

FIG. 7 illustrates an exemplary GUI that shows one category per List in accordance with an embodiment of the invention;

FIG. 8 illustrates an exemplary GUI that shows a Subjects List in accordance with an embodiment of the invention;

FIG. 9 illustrates an exemplary GUI that shoes a Block Log List in accordance with an embodiment of the invention;

FIG. 10 is a flow diagram that shows an exemplary operation of an e-mail management service in accordance with an embodiment of the invention; and

FIG. 11 is a flow diagram that shows an exemplary operation of sending a Block Log List and interaction with a user in accordance with an embodiment of the invention.

### DETAILED DESCRIPTION

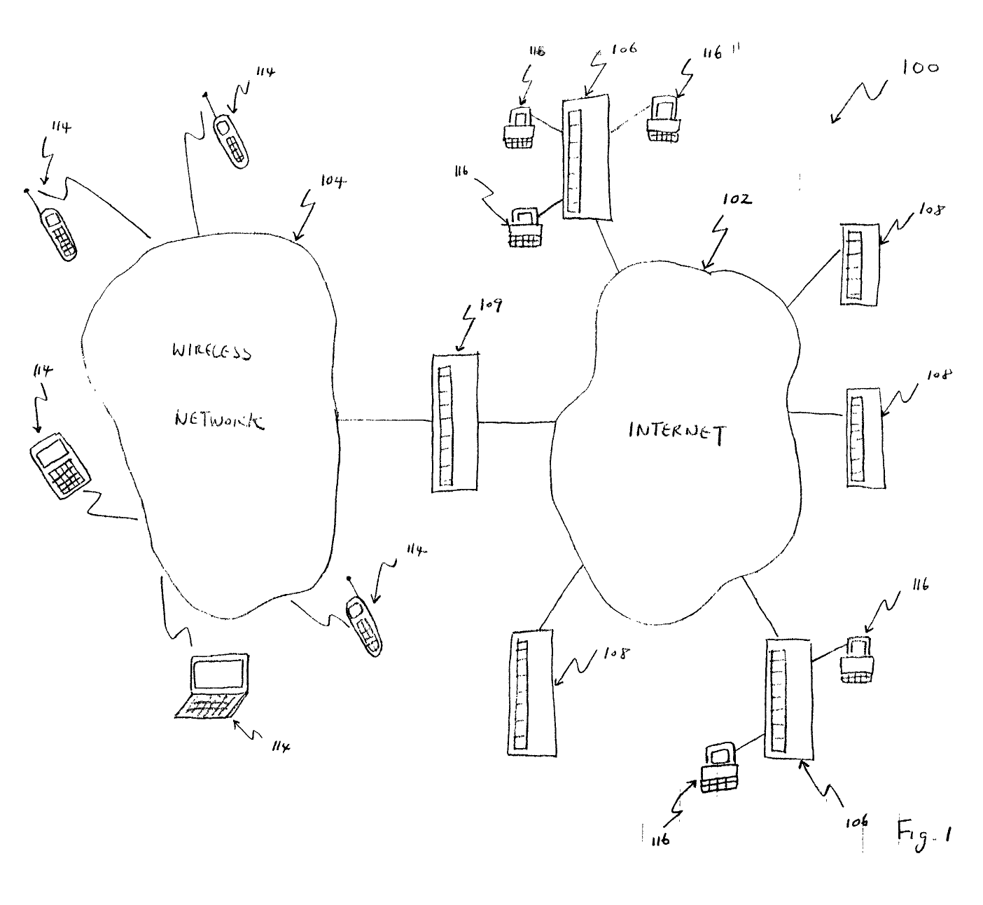

FIG. 1 illustrates one possible network environment 100 in which an electronic information management service may be used. The network environment 100 comprises the Internet 102, a wireless network 104 and a plurality of servers 106, 108, 109. Computers 116 such as Personal Computers (PCs), laptop computers and the like may be coupled to one or more servers 106 and wireless devices 114 such as mobile phones with Wireless Access Protocol (WAP) capability, wireless Personal Digital Assistants (PDAs), laptop computers with wireless capability and the like are wirelessly coupled to the wireless network 104. While the invention contemplates all forms of electronic information such as audio, video, text and image, for sake of simplifying the understanding of the invention, further descriptions below will refer to an electronic mail (e-mail) management service.

The Internet 102 is commonly represented as a cloud comprising of routers, bridges, switches, repeaters and the like that are interconnected together to transmit data in packet form from a source node to a destination node. A node is usually a gateway server 106 that acts as gateways to allow, for instance, PCs 116 to connect to the Internet 102 (the entity that provides this service is known as an Internet Service Provider (ISP)) or it is a resource server 108 that provides resources such as information, services and transactions. It should be noted that a gateway and a resource may both be contained in one server. A subset of the Internet, the World Wide Web (www) houses millions of Web pages that are stored in “Websites” at the various servers 106, 108, 109, wherein the Website may be addressed by its unique Uniform Resource Locator (URL). The URL, among other information, contains the Website's domain name that identifies the creator of the Website. A user on a PC 116 connected to the Internet 102 may use a Web browser such as Microsoft's Internet Explorer or Netscape's Navigator to access the Website by entering the Website's URL.

The preferred mode of transmission in the Internet 102 is Transport Control Protocol/Internet Protocol (TCP/IP) or User Datagram Protocol/Internet Protocol (UDP/IP). Wireless devices 114 are connected to the Internet 102 via a wireless network 104 that has access to the Internet 102 through a Wireless Access Protocol (WAP) gateway server 109. For users of the Internet 102, the ISP usually provides a graphic user interface (GUI) that is installed in the user's computer 116 or wireless device 114 that interacts with the installed browser to connect to the ISP's server. Once a connection is established, the user may access one of the many features provided by the ISP such as news, sports or stock quotes, or use a “search engine” to search for interesting Websites, or enter a URL that directly connects the user to the Website.

To retrieve e-mail, for example from Web-based e-mail, an ISP provides an e-mail account that prompts the user upon login if the account has mail. Usually, by clicking an e-mail icon visible on the GUI, the user is shown a list of e-mails that have been received. In another instance, the user may access an employer Website that allows the user to access a business e-mail account set by the employer, for example, to provide internal and external correspondences related to the course of the business. In yet another instance, the user may access a commercial or non-commercial Website that allows the user to set up and maintain an e-mail account for the user's personal use. The above mentioned e-mail addresses sometimes referred to herein as “primary e-mail addresses,” may be difficult to manage due to its numerousity and well as the time and locality of the user. Alternatively, the user may access an e-mail server that, upon identifying and authenticating the user, downloads the e-mails to the user's device.

Usually, by creating e-mail accounts, such as on various Websites, the user exposes oneself to SPAM that is periodically deposited into the user's e-mail account. In many instances, the user's Internet activities provides the SPAM distributor with the e-mail address with which SPAM can be sent.

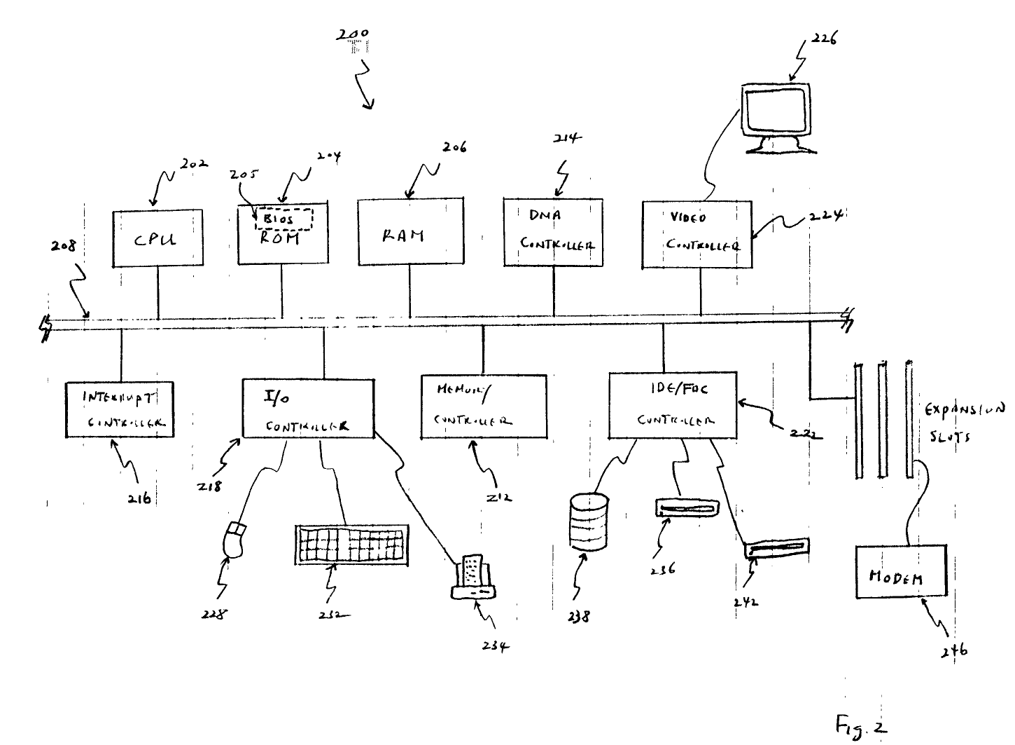

FIG. 2 illustrates a commercially available general-purpose computer 200 such as International Business Machine (IBM) compatible Personal Computer (PC) or a computer manufactured by Apple Computer Inc. and the like, that the user may use to connect to the gateway server 106. As is well known in the art, the computer 200 comprises a central processing unit 202 (CPU), a read only memory (ROM) 203 usually containing a Basic Input Output System (BIOS) 205, a main memory 206 usually represented by random access memories (RAMs) and various controllers 212, 214, 216, 222, 224, all connected together through a system bus 208. Attached to the computer are various peripheral devices such as a keyboard 232, a mouse 228, disk drives such as a Fixed Disk drive 238, a Floppy drive 234 and a Compac Disc (CD) ROM Drive 242, a video monitor 226, a printer 234, a modem 246 and the like via pertinent controllers that allow the computer 200 to communicate with the user or the outside world. Usually contained in the Fixed Disk drive 238 is an operating system, a portion which when the computer is activated, resides in the main memory 206; a Web browser, an ISP provided GUI, application programs such as word-processor, spreadsheets and the like, which when called by the user via a mouse 228 or keyboard 232 is retrieved from the Fixed Disk drive 238 and resides in the main memory 206.

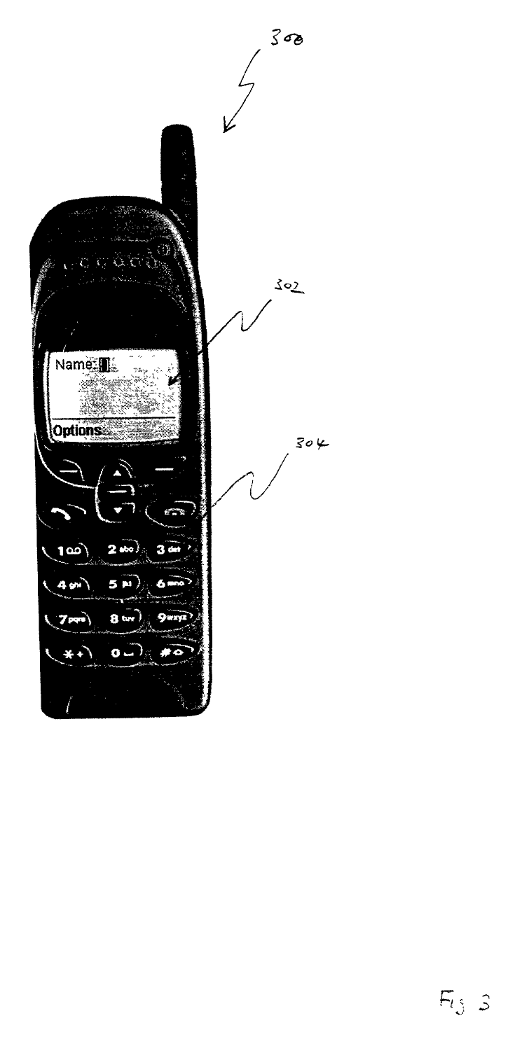

FIG. 3 illustrates a mobile phone 300 with implemented Wireless Access Protocol (WAP) that provides connection to the Internet 102 via the WAP gateway server 109. The mobile phone 300 usually has a limited display 302 and input capabilities (in a form of limited alphanumeric keypad 304) that does not allow for sophisticated commands and displays, and usually exchanges information and selections via short messaging service (SMS). Interaction with a WAP site in the Internet usually comprises accessing e-mail messages, receiving stock quotes, weather reports, limited stock transactions and the like.

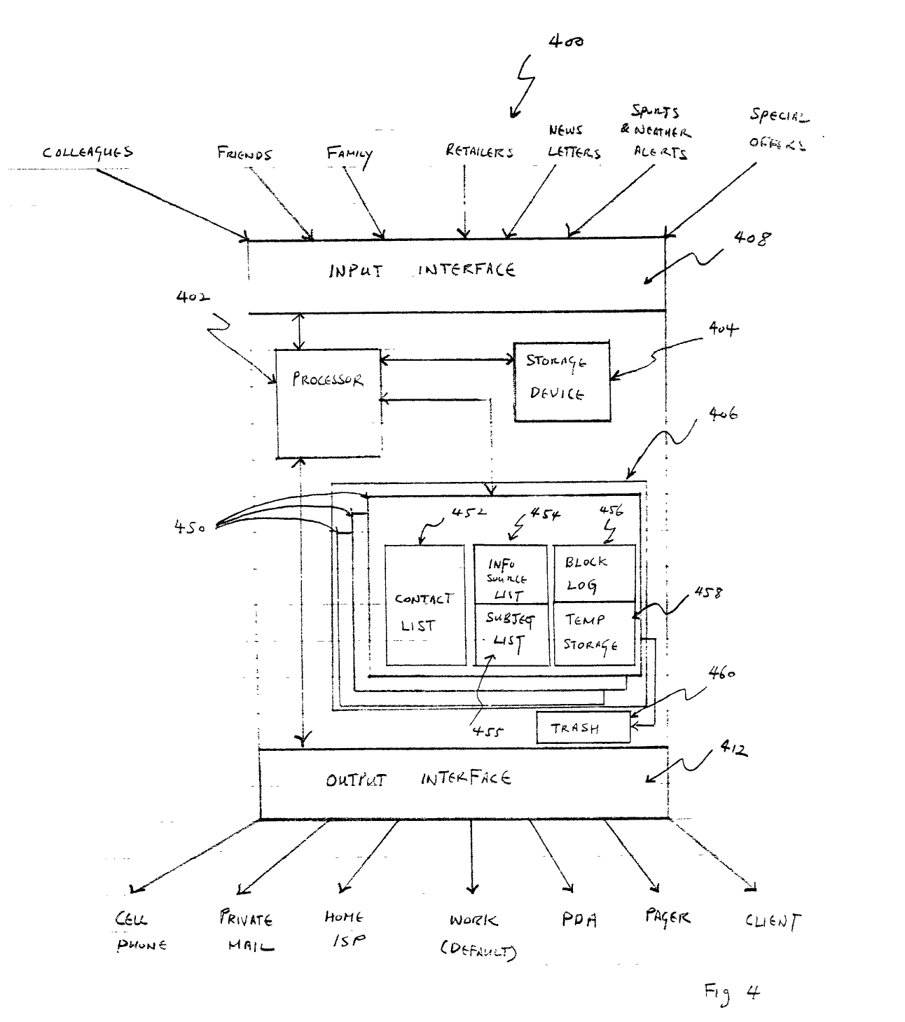

FIG. 4 is a schematic of an e-mail management server 400 in accordance with an embodiment of the invention. The server hardware is commercially available, for instance, from Sun Microsystems Inc., Compaq Computer Corporation and the like and comprises a processing unit 402, a storage device 404 such as a Fixed Disk drive and a main memory 406 that are in communication with each other. The server 400 further comprises an input interface 408 and an output interface 412 to receive and transmit data respectively and are coupled to the processing unit.

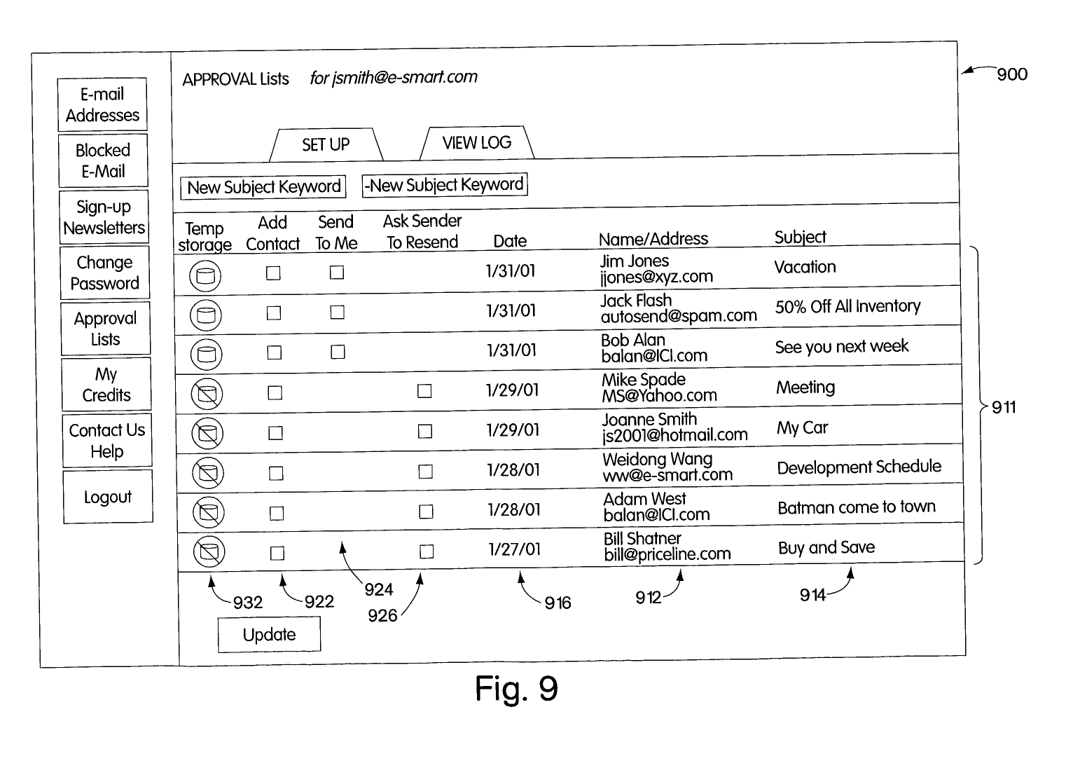

In accordance with an embodiment of the invention, the modules 452, 454, 455, 456, 458 that form the e-mail management service 450 are implemented as computer instructions contained in a computer readable medium such as a Fixed Disk drive, a non-volatile semiconductor memory such as Read Only Memory (ROM) or Flash memory, a volatile memory such as RAMs or coded electrical signals transitioning through wired or wireless medium. The e-mail management service 450 comprises a Contact List 452, an Information Source List 454, a Subject List 455, a Block Log List 456 and a Temporary Storage 458 for each user that has access to the e-mail management service 450. When the server containing the e-mail management service 450 is active the modules 452, 454, 455, 456, 458 are called into the main memory 406 and control the operation of the processing unit 402 in regards to e-mail management. For each user, the Contact List 452 usually comprises e-mail addresses of persons such as colleagues, friends and family. The Information Source List 454 usually comprises commercial, non-commercial or non-profit organizations and entities such as retailers, newsletters, sports and weather alerts, entities that push special offers and the like. The Subject List 455 usually comprises words and/or phrases and/or boolean combination of words and/or phrases that is used to filter e-mail. The Contact List 452, the Information Source List 454 and the Source List 455 may be inclusive lists, exclusive lists or a mixture or combination of both depending on the desired results. The Block Log 456 usually contains e-mail addresses and associated pertinent information (further described with respect to FIG. 9) that were blocked by the e-mail management service 450 from being transmitted to the user, for example, because the e-mail address was not in the inclusive Contact List 452, Information Source List 454 and/or inclusive Subject List 455.

In another embodiment, the e-mail address may have been blocked because it was processed as being in an excluded Contact List 452, Information Source List 454 and/or Subject List 455. It should be noted that the List examples given are not exhaustive, but examples of Lists that may be used. Further, it should be noted that one or more Lists may be used in combination to filter e-mail messages. The Temporary Storage 458 stores the blocked e-mail addresses and associated messages, usually for a limited period of time, should the user decide to retrieve the blocked e-mail message. If the e-mail address is deleted or unopened during the limited period of time mentioned above, the server 400 discards the e-mail address along with its contents into the trash 460.

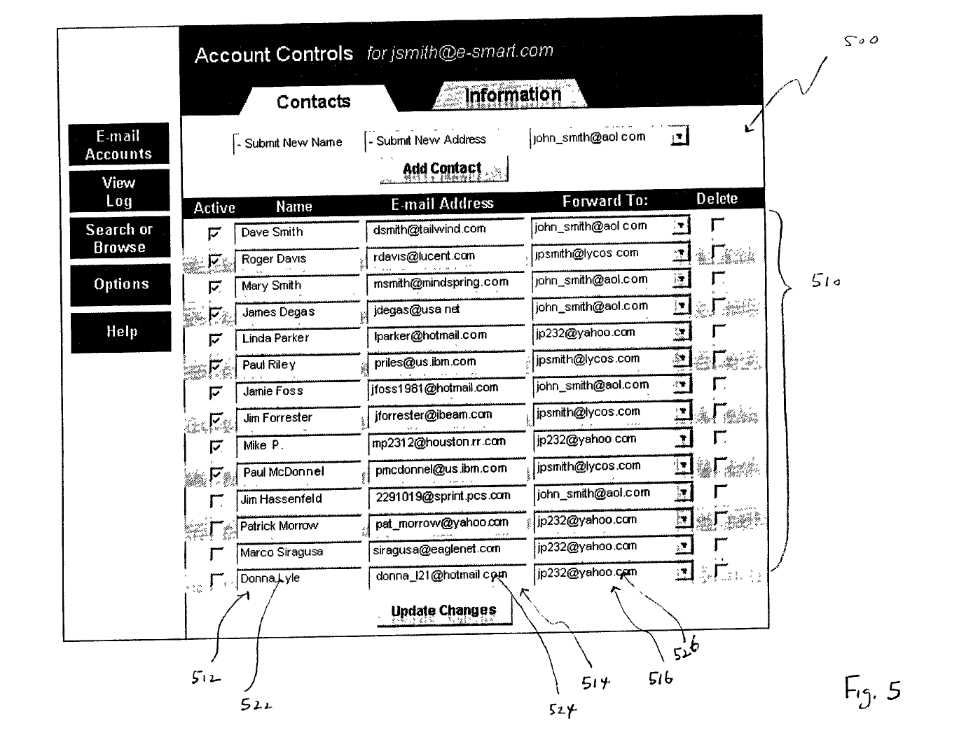

FIG. 5 illustrates a Contact List 500 in accordance with one embodiment of the invention. The Contact List 500 may be represented in a GUI that is provided by the e-mail management service via its Website or the GUI is stored in the user's computer. The Contact List 500 comprises a plurality of records 510 having one or more fields 512, 514, 516. In the first field 512, a name of a contact 522 is recorded. In the second field 514, an e-mail address 524 associated with the name of the contact is recorded (sometimes referred to as source e-mail address herein). In the third field 516, a desired forwarding e-mail address 526 if the e-mail address of the second field is intercepted is recorded (sometimes referred to as primary e-mail address herein). Although the insertion, addition and modification of the records and fields may be performed by an administrator of the e-mail management service, preferably, the user is able to perform those routines through the GUI after the user has registered for the e-mail management service.

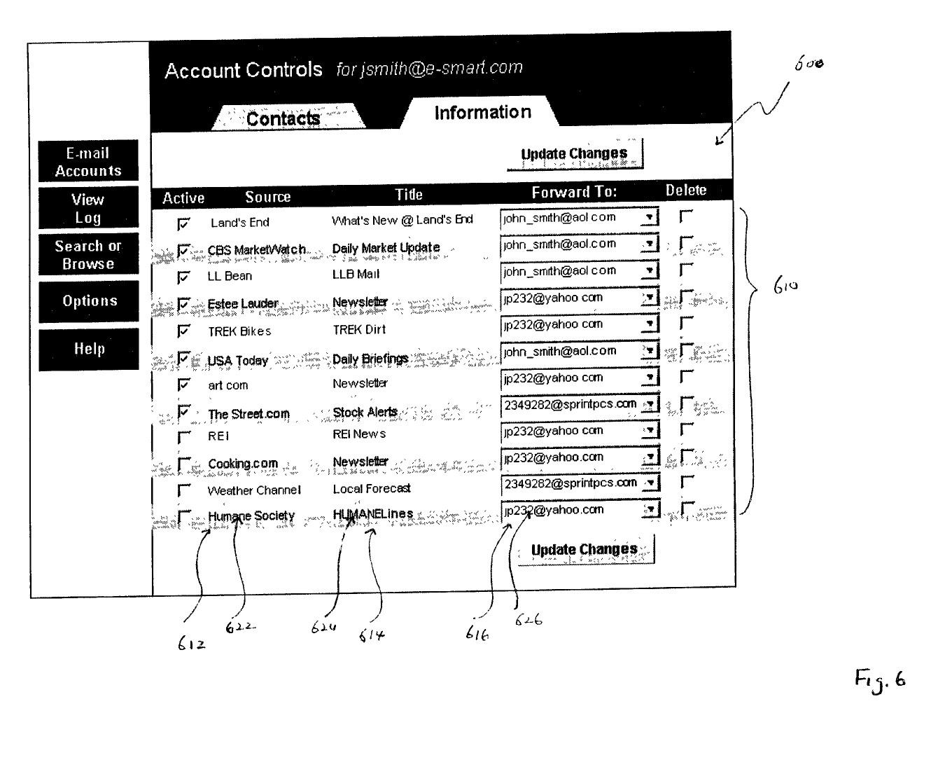

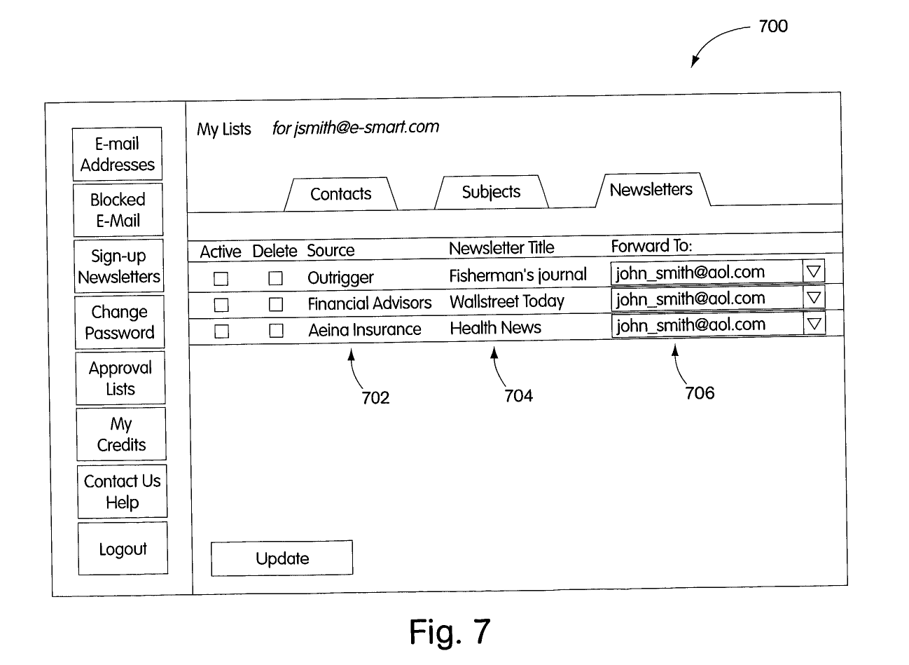

FIG. 6 illustrates an Information Source List 600 in accordance with one embodiment of the invention. The Information Source List 600 may be represented in the GUI as in FIG. 5. The Information Source List 600 comprises a plurality of records 610 having one or more fields 612, 614, 616. In the first field 612, a name 622 of an information source is recorded. In the second field 614, a title 624 of the information that is provided by the information source is recorded. In the third field 616, a desired forwarding e-mail address 626 for the information if the e-mail address of the information source in the first field is intercepted is recorded. Although the insertion, addition and modification of the records and fields may be performed by an administrator of the e-mail management service, preferably, the user performs those routines. The Information Source List 600, however, need not have all categories of information stored in one List. For example, FIG. 7 illustrates one of the many separate Lists that the user may form to store one category per List. In this instance, FIG. 7 illustrates a Newsletters List 700 that lists news sources 702 and news titles 704 that are of interest to the user along with the forwarding address 706 of the destination desired by the user.

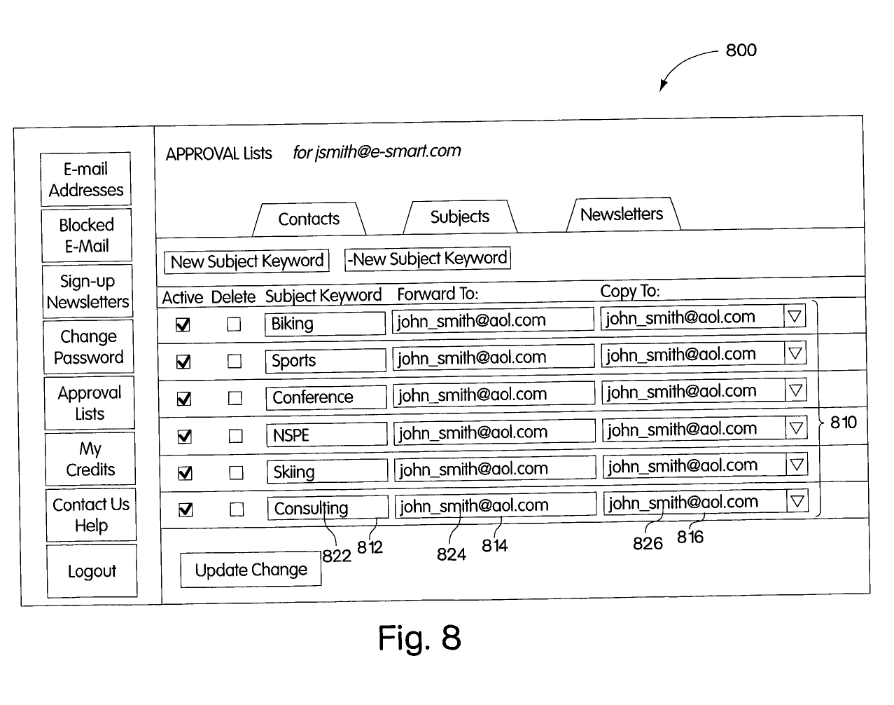

FIG. 8 illustrates a Subjects List 800 in accordance with one embodiment of the invention. The Subjects List 800 may be represented in the GUI. The Subjects List 800 comprises a plurality of records 810 having one or more fields 812, 814, 816. In the first field 812, a keyword 822 of the subject is recorded. While the figure shows one word, it should be noted that words and/or phrases and/or boolean combination of words and/or phrases may be used to filter e-mail. In the second field 814, a desired forwarding e-mail address 824 of the e-mail that contains the keyword 822 is recorded. In the third field 816, which may be optional, a copy e-mail address 826 of the e-mail that contains the keyword 822 is recorded.

FIG. 9 illustrates a Block Log List 900 in accordance with one embodiment of the invention. The Block Log List 900 may be represented in the GUI. The Block Log List 900 may be accessed through the Website, for example, when requested by the user or the List may automatically show up in the user's screen when the user logs in. In another embodiment, the Block Log List 900 is transmitted to the user's device at regular intervals such as daily, weekly or other periodic times. The Block Log List 900 comprises a plurality of records 910 having one or more fields 912, 914, 916, 922, 924, 926 and icons 932. In the first field 912, the name and source address of the blocked e-mail is recorded. In the second field 914, the title or subject of the e-mail is recorded. In the third field 916, the date of the receipt of the e-mail is recorded. The fourth field 922 may be used to update one or more of the Contact List 500, Information List 600 and the Subject List 800 should the user decide to include the name and source address, title of the information and/or keyword to one or more of the mentioned Lists.

The fifth field 924 is a check box or it may be a “link” to the e-mail management service that is used to request the content of the e-mail associated with the name, source address, title or subject in the record. When checked or clicked, a request is sent to the e-mail management service that looks for the e-mail of the requested the name, source address, title or subject in the Temporary Storage 458 (see FIG. 4), retrieves the e-mail and forwards it to the destination address that generated the request. The sixth field 926 is a “ask sender to resend” request that may be used to request the sender to resend the e-mail. In the meantime, the user or the e-mail management service will add the source address to the appropriate List so that the resent e-mail can be received. Resend requests may be performed through the e-mail management service so the user's primary e-mail addresses are maintained confidential. Alternatively, a Resend Request from the e-mail management service may request the original sender to send the e-mail directly to the requesting user. The icon 932 indicates whether the e-mail is available in Temporary Storage 458 at the time the Block Log List 900 was sent.

According to one aspect of the invention, the features provided in the Block Log List 900 in conjunction with the other Lists such as the Contact List 500, the Information Source List 600, the Subject List 700 provides for a filtering system that effectively filters SPAM and other undesired e-mails, while allowing the user to control and manage the user's e-mail in a manner such that the user receives the desired e-mail at the time and locale of the user while maintaining the user's primary e-mails private.

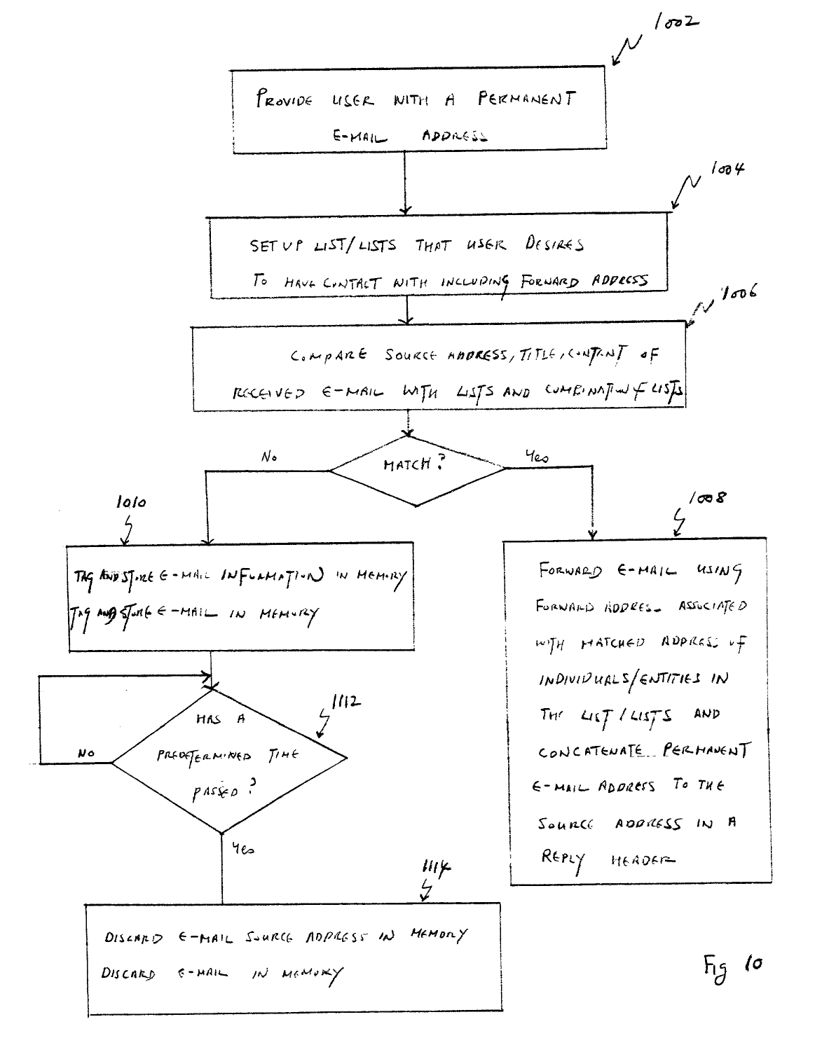

FIG. 10 represents a flow chart that performs an exemplary e-mail management service. At stage 1002, a user of the e-mail management service is provided with an account and an e-mail address unique to the account. The user provides this e-mail address to any person or entity that the user desires to have contact with. For example, the user may provide this e-mail address (herein referred to as “permanent e-mail address”) to friends, colleagues, family, retailers, information sources such as newsletters, sports and weather alerts, and entities that push special offers. At stage 1004, with reference to FIG. 5, FIG. 6 and FIG. 8, the e-mail management service sets up a Contact List, an Information Source List and a Subject List associated with the user's account that is indicative of the contacts, sources and words/phrases that the user desires to receive e-mail from. The e-mail address used in the Internet includes both the identification of the user and the domain name of the user's e-mail servicing server. At stage 1006, the processing unit using a conventional parsing routine parses the address header of the e-mail to retrieve a source address. The source address is compared with the listed source addresses in the Contact list and/or the Information Source List to determine if the e-mail should be forwarded. The processing unit checks the title of the e-mail to determine if the title is in the Information Source List that determines whether the e-mail should be forwarded. The processing unit may also compare the e-mail content with the Subject List to determine if the e-mail should be forwarded. It should be noted that combinations of Lists may be used to determine if the e-mail should be forwarded.

At stage 1008, if there is a match and the e-mail should be forwarded, the processing unit retrieves the forwarding addresses in matched records of one or more Lists. Additionally, the processing unit inserts one or more address headers in the e-mail that allows the recipient at the forwarding address to respond to the sender through the e-mail management server such as “reply.” In one embodiment of the invention, the processing unit concatenates the user's permanent e-mail address to the source address and inserts the concatenated source address/user permanent e-mail address in the reply header. Thus, if the user desires to respond to the e-mail message, the user simply clicks the reply header and types in the reply message. The reply message is then forwarded to the e-mail management server, wherein the processing unit in the server recognizes the concatenated address, detaches the user permanent e-mail address and the previous user forwarding address, and forwards the reply message to the source address.

Alternatively, if there is no match, at stage 1010, the e-mail and the source address are channeled to the Temporary Storage and the Block Log. In accordance with an embodiment of the invention, for users that request the blocked e-mails to be sorted such as by keywords, the e-mail management service tags the source address and/or the e-mail with the matching keyword before storage. This feature allows the blocked source addresses and/or e-mails to be sorted into separate folders when presented to the user such that the user may selectively view the blocked source address and e-mails according to the keyword. Examples of keyword may be found with respect to FIG. 8, although the sorting method other than keywords may be used such as at least portions of e-mail addresses, titles, subject and the like. At stages 1112-1114, after a predetermined period, the stored e-mail and the source address is discarded from the Temporary Storage and the Block Log List respectively.

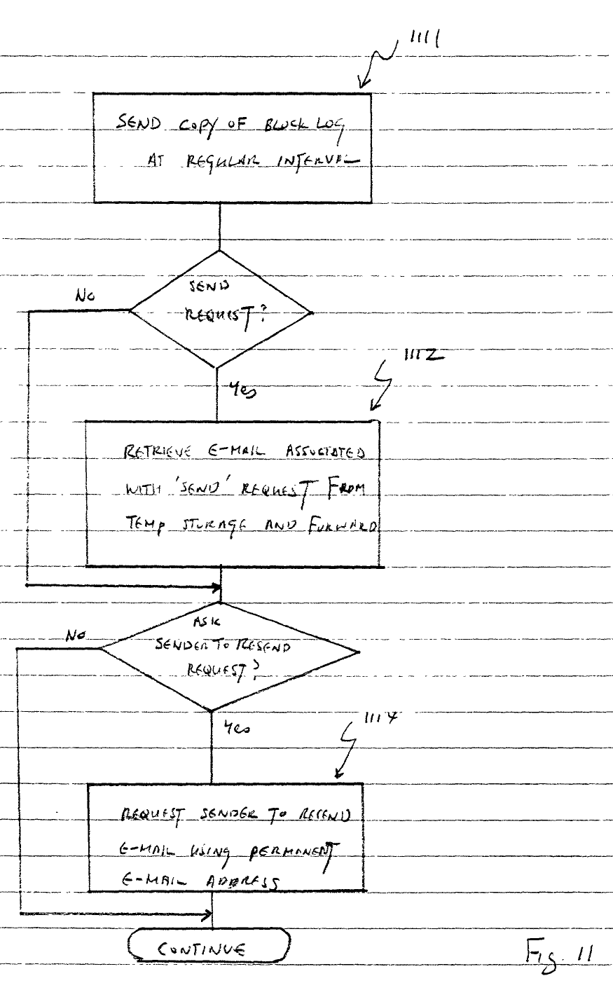

With reference to FIG. 11 As an optional stage, at stage 1111, on a regular interval which may be daily or weekly or any other interval, the e-mail management service sends the user of the account a copy of the Block Log List. Alternatively, the user may access the Block Log List at the e-mail management service. As previously mentioned, the user may access several folders in which the blocked e-mails are sorted according to keywords or the like, or there may be a pre-arrangement in which folders with keywords selected by the user are accessed, with perhaps the other folders accessible to the user if requested. At stage 1112, if a “send” for a blocked e-mail request is received, the e-mail management service searches the Blocked Log 456 and/or the Temporary Storage 458 (see FIG. 4) to determine if the e-mail can be retrieved. If the e-mail is still available the e-mail management service forwards the e-mail to the destination address of the send request or some other designated destination address. If the requested e-mail has been discarded then the e-mail management service sends an e-mail or signal indicating that the e-mail has been discarded. At stage 1114, if a “Ask Sender to Resend” request is received from the user, the e-mail management service makes the request to the source address, perhaps using a preformatted resend request that includes information on the e-mail previously sent by the source address, which has been stored in the Block Log.

One or more advantages may be derived from the described embodiments of the invention. From the user point of view, the need to notify individuals and entities is eliminated when the user's primary e-mail addresses change. The user does not need to re-subscribe to newsletters, alerts and etc. when the user's primary e-mail address change. The user may easily divert and redirect information and e-mails to a preferred e-mail destination. The user is able to maintain a consolidated list of contacts and subscriptions to information sources. The user is able to block SPAM, wherein the e-mail management service acts as a firewall. From an employer or organization point of view, the use of the e-mail management service reduces e-mail address churn. The service provides privacy to the user's primary e-mail addresses.

Although various embodiments of the application have been described, it will be apparent to those of ordinary skill in the art, and many more embodiments and implementations are possible within the scope of the invention. Accordingly, the invention is not to be restricted, but should be read in light of the attached claims, and their equivalents.

What is claimed is:

1. A method for providing electronic mail (e-mail) management service comprising:
providing a user with a distribution address that the user uses to distribute to at least one of persons and entities that the user desires to have contact with;
setting up at least one of persons and entities address in a list that the user desires to have contact with;
setting up a forwarding address that is associated with at least one of persons and entities address on the list;
receiving e-mail with a source address;
comparing the source address with the list that the user desires to have contact with; and
retrieving a forwarding address and forwarding the e-mail if the source address matches at least one of persons and entities address in a list.

2. The method as in claim 1, further comprising:
storing at least one of the source address and the e-mail in a storage area if the source address does not match at least one of persons and entities electronic address in the list.

3. The method as in claim 2, further comprising:
allowing the user to review at least one of the source address and the e-mail stored in the storage area; and
allowing the user to retrieve at least one of the source address and the e-mail stored in the storage area.

4. The method as in claim 3, further comprising:
allowing the user to update the list to include the source address in the storage area.

5. The method as in claim 2, further comprising:
discarding at least one of the source address and the e-mail stored in the storage area after a pre-determined period of time.

6. A method for providing electronic mail (e-mail) management service comprising:
providing a user with an access to a server;
allowing the user to obtain a distribution address at the server that the user uses to distribute to at least one of persons and entities that the user desires to have contact with;
setting up in the server at least one of persons and entities address in a list that the user desires to have contact with;
setting up in the list a forwarding address that is associated with at least one of persons and entities address on the list;
receiving at an input interface of the server, e-mail including a source address that is channeled to the server using the distribution address;
comparing at the server, the source address with the list that the user desires to have contact with;
retrieving a forwarding address if the source address matches at least one of persons and entities address in a list; and
sending the e-mail along with the forwarding address to an output interface of the server.

7. The method as in claim 6, further comprising:
storing at the server, at least one of the source address and the e-mail in a storage area if the source address does not match at least one of persons and entities electronic address in the list.

8. The method as in claim 7, further comprising:
allowing the user to review at least one of the source address and the e-mail stored in the storage area of the server; and
allowing the user to retrieve at least one of the source address and the e-mail stored in the storage area.

9. The method as in claim 8, further comprising:
allowing the user to update the list at the server to include the source address in the storage area.

10. The method as in claim 7, further comprising:
discarding at least one of the source address and the e-mail stored in the storage area of the server after a predetermined period of time.

11. An apparatus to provide electronic mail (e-mail) management service comprising:
means for providing a user with a distribution address that the user uses to distribute to at least one of persons and entities that the user desires to have contact with;
means for setting up at least one of persons and entities address in a list that the user desires to have contact with;
means for setting up a forwarding address that is associated with at least one of persons and entities address on the list;
means for receiving e-mail with a source address;
means for comparing the source address with the list that the user desires to have contact with; and
means for retrieving a forwarding address and forwarding the e-mail if the source address matches at least one of persons and entities address in a list.

12. The apparatus as in claim 11, further comprising:
means for storing at least one of the source address and the e-mail if the source address does not match at least one of persons and entities electronic address in the list.

13. The apparatus as in claim 12, further comprising:
means for allowing the user to review at least one of the source address and the e-mail stored in the storage means; and
means for allowing the user to retrieve at least one of the source address and the e-mail stored in the storage means.

14. A system to provide electronic mail (e-mail) management service comprising:
an e-mail management service server that includes
a processor configured to provide a distribution address to a user that the user uses to distribute to at least one of persons and entities that the user desires to have contact with;
a memory to store a list that includes at least one of persons and entities address that the user desires to have contact with, the list further includes at least one forwarding address that is associated with at least one of persons and entities address on the list;
an input interface to receive e-mail with a source address, wherein the processor is further configured to compare the source address with the list containing at least one of persons and entities address, the processor further configured to retrieve the forwarding address if the source address matches at least one of persons and entities address in the list, the memory further configured to store at least one of the source address and the e-mail if source address does not match at least one of persons and entities address in the list, wherein the processor is configured to allow the user to have access to the stored at least one of the source address and the e-mail; and
an output interface to forward the e-mail using the forwarding address.

15. The system as in claim 14, further comprising:
a network coupled to the server.

16. The system as in claim 15, wherein the network is Internet.

17. The system as in claim 16, further comprising:
a plurality of servers coupled to the Internet and in communication with the e-mail management service server.

18. The system as in claim 16, further comprising:
at least one computer coupled to a server that is in communication with the e-mail management service server, the computer includes
a graphic user interface (GUI) that is configured to communicate with the e-mail management service server.

19. The system as in claim 15, wherein the network is a wireless network.

20. The system as in claim 19, further comprising:
at least one wireless device coupled to the wireless network, wherein the wireless network is in communication with the e-mail management service server and the wireless device includes a graphic user interface (GUI) that is configured to communicate with the e-mail management service server.
